(19) United States
(12) Patent Application Publication
(10) Pub. No.: US 2008/0102653 A1
(43) Pub. Date: May 1, 2008

(54) ELECTRONIC BOARD WITH TWO OR MORE BOARD EDGE CONNECTORS AND A METHOD FOR ADAPTING THOSE CONNECTORS

(76) Inventors: Kobi Adulami, Rosh Haayin (IL); Gideon Kaempfer, Raanana (IL)

Correspondence Address: SMITH FROHWEIN TEMPEL GREENLEE BLAHA, LLC, Two Ravinia Drive, Suite 700, ATLANTA, GA, 30346, US

(21) Appl. No.: 11/923,715

(22) Filed: Oct. 25, 2007

Related U.S. Application Data
(60) Provisional application No. 60/863,154, filed on Oct. 27, 2006.

(51) Int. Cl. H01R 12/18

(52) U.S. Cl. 439/59

(57) ABSTRACT

Cards with multiple card-edge connectors constructed as printed male connectors are structured for a more reliable interface to mating female receptacles. A typical specification that defines the width of a male connector and the width of its conductive fingers as well as its mating female connector, does not define the specification of a two or more edge connectors. In a multiple connector card, these parameters are modified on at least one of the male connectors to obtain a more reliable connection. The modifications may include increasing the width of the conductive fingers and/or decreasing the width of the connector, for example.

### CROSS-REFERENCE TO RELATED APPLICATIONS

This application is a nonprovisional application filed pursuant to 35 U.S.C. 1.53(b) and claims the benefit of the filing date of the United States provisional application for patent that was filed on Oct. 27, 2006, assigned Ser. No. 60/863,154 and bearing the title of ELECTRONIC BOARD WITH TWO OR MORE BOARD EDGE CONNECTORS AND A METHOD FOR ADAPTING THOSE CONNECTORS, which application is hereby incorporated by reference.

### BACKGROUND OF THE INVENTION

The subject matter of the present disclosure relates to an electronic card that includes card-edge conductive fingers (gold fingers) as an interface to the card and, in particular, to an electronic card having two or more sets of card-edge conductive fingers. The two or more sets of card-edge conductive fingers can be used for connecting the card to mate with female edge connectors on a motherboard. The motherboard can be a backplane of an electronic device or a carrier board in the case that the card is a mezzanine card.

Frequently, electronic equipment includes one or more electronic cards (also referred to as printed circuit boards, PCB). Often, these electronic cards (PCB) are designed to be inserted into a motherboard. When the PCB is a mezzanine card or a daughter card, the motherboard can consists of another electronic board (a carrier board). In other situations, the motherboard can be a backplane, or mid-plane of the electronic device as an example.

The electronic cards typically include one or more card-edge conductive fingers as the card-edge interface for connecting the PCB to the housing or other equipment within the housing, such as a backplane, motherboard or to a carrier board. Due to variations that may exist in card sizes and tolerances, it can be difficult to align the card-edge interface with the associated connectors on the motherboard (a backplane or a carrier card). This is particularly troublesome when the card includes more than one card-edge interfaces. As a result, there can be a poor or unreliable connection between the card and the motherboard.

A few attempts have been made to provide a solution to the problem of aligning two or more card-edge interfaces (connection sets). One prior such attempt enables a user to make on-site modifications to the connectors, either by adjusting the connector on the card or the backplane or the carrier card. However, on-site modifications can result in creating additional problems, such as loose connections to the cards, damage to other circuitry on the card, and generating modified cards that are no longer in conformance with a standard. Another attempted solution uses a pair of a male connectors on the PCB and a female connectors on the carrier card. Each pair of connectors is designed to overcome positioning errors between the two cards. Another attempted solution that is disclosed in the US Patent Application Publication No. US 2005/0239310 offers the use of floating pairs of connectors (male and female) per each connection set. The floating connectors have the flexibility to overcome some of the problem associated with misalignment of the connectors.

Today, in light of technological advances, the size of electronic devices are becoming smaller. Therefore, the electronic boards within these electronic devices must also be reduced in size. The size reduction in electronic boards can result in forcing the card-edge connector to likewise be reduced in size. To accommodate this size reduction, the gaps between the gold fingers (conductive traces, printed male pins) on the printed circuit board as well as the terminals inside the card edge female connector have to be reduced in size. Furthermore, all of these size reduction requirements are made more challenging by the fact that there is an ever-existing need or desire for an increase in the input and output communication bandwidth flow between electronic cards. Such requirements result in a need to use high density connectors which typically include a large number of pins, fingers and conductors. These two factors (reduced size and need for increased bandwidth) further exasperate the board alignment problem. In some cases, the alignment problem is so critical that design specifications for boards forbid having more than one edge connector on a board. For example, The PICMG Advance Mezzanine Card AMC.0 Specification R1.0 ECR-002 D0.8, dated Apr. 28, 06, defines the interface between a mezzanine card (a daughter card) and a carrier card (the AMC.0 Specification). On pages 2-9 of this specification, it describes the requirements identified as “Double Modules shall have only one edge connector in the lower position . . . ”. The content of the AMC.0 Specification R1.0 ECR-002 D0.8 date Apr. 28, 06 is incorporated herein by reference.

Typically, specifications that define an interface between a PCB having contact fingers and a motherboard (a backplane or a carrier card) define the common elements for the PCBs and the motherboard. Such a specification can define the mechanical size of the PCB; keep-out zones; the PCB face section; the PCB edge interface for interfacing with the motherboard; the bay mechanism with a female edge connector of the motherboard, for interfacing and supporting the PCB.

FIG. 1 is a schematic diagram illustrating relevant features of an edge of a PCB 100 that can be defined by such specification. Among other parameters, the specification can define the width ‘L1’ of the PCB 100 and its tolerance; the width L2 of the PCB card interface (male connector) 120 and its tolerance; the pitch ‘P’ between the golden fingers 122 and its tolerance; the width ‘W’ of each golden finger 122 and their tolerance; a central line ‘M’ for defining the relation between the different elements, etc. More information related to such parameters and other specifications and characteristics of PCB board connectors can be found in AMC.0 Specification R1.0 ECR-002 D0.8 date Apr. 28, 06. For example, when the child card is a single module PCB that matches the AMC.0 Specification then L1 is defined as 73.5±0.1 mm; L2 is defined as 65+0.1 mm; ‘P’ is defined as 0.75 mm; ‘W’ is defined as 0.48+0.02 mm. The AMC.0 Specification R1.0 ECR-002 D0.8 date Apr. 28, 06 is used as an exemplary specification of an interface between a child card and a carrier. The present invention is not limited to the AMC.0 Specification.

When there is a need for a large number of components on the PCB, a double size PCB can be used. However, adding a second printed male connector to increase the bandwidth is not recommended by the AMC.0 Specification. If one tries to add a second printed male connector using the defined parameters of a single printed male connector (parameters like ‘L2’, ‘P’ and ‘W’), then connection problems may be created.

It should be noted that the terms “conductive finger”, “conductive trace”, “printed male pin”, “contact finger” and “gold finger” can be used interchangeably herein. It should be noted that the terms “card-edge interface”, “set of card-edge conductive fingers” and “card-edge printed male connector” can be used interchangeably herein. Moreover, it should be noted that the terms “motherboard”, “carrier card” and “backplane” can be used interchangeably herein. Last but not the least, it should be noted that the terms “PCB”, “daughter card”; “a mezzanine card” and “child card” can be used interchangeably herein.

What is needed therefore is a new method for adding one or more card-edge printed male connector to a PCB. Such a PCB can have high density throughput to fulfill the bandwidth and the size of the current needs.

### BRIEF SUMMARY OF THE INVENTION

The various embodiments, aspects and features of the present invention address the above-described needs in the art, as well as other needs in the art, by using an interface structure that provides a more reliable connection between a card with multiple printed mail connector card-edge interfaces and another structure having mating female receptacles. In general, specifications are provided for various parameters of a printed mail connector card-edge interface that mates to a female receptacle. These parameters include the width of the card-edge interface, the width of the conductive fingers, and the periodicity of the conductive fingers. When a multiple-connector board is constructed within these single-connector board guidelines, some level of unreliability is created between the connector interfaces.

In one embodiment of the invention, one or more parameters of the printed mail connector card-edge interface are modified to improve the reliability of the connection.

More specifically, in one embodiment of the invention, the width of the card-edge connector is decreased from the specified size (such as by less than 1% up to 15%). In another embodiment, the width of the conductive fingers can slightly be increased (such as by 1% to 25%). In yet another embodiment, the width of the card-edge connector can be decreased by less than 1% up to 15% from the specified width and the width of the conductive fingers can be increased by 1% to 25% from the specified width.

In another embodiment, the above-described modifications are provided in only a single one of the multiple-connectors of a card. In yet another embodiment, the above-described modifications are provided in both or all of the multiple-connectors. In yet even another embodiment, the modifications are applied to both connectors of a two-connector board but, the percentage of change can vary between the various connectors.

Advantageously, these structures improve the reliability of the connections established between the inserted cards and the female receptacles.

### BRIEF DESCRIPTION OF THE SEVERAL VIEWS OF THE DRAWING

Exemplary embodiments, features and aspects of the present invention will be more readily understood from reading the following description and by reference to the accompanying drawings, in which:

FIG. 1 is a schematic view showing relevant features of an edge of a PCB having a conventional card-edge interface (a male connector) having golden fingers;

FIG. 2 is a schematic diagram an exemplary double size child card having two card-edge interfaces (male connectors); and

FIG. 3 is a schematic diagram of another exemplary double sized child card having two card-edge interfaces (male connectors).

### DETAILED DESCRIPTION OF EMBODIMENTS OF THE INVENTION

In general, the various embodiments of the present invention are directed towards obtaining reliable and quality connections between a child card and a motherboard for situations in which the child card has at least two card-edge printed male connectors. Furthermore, exemplary embodiments of the present invention achieve such connections by modifying certain dimensions of at least one card-edge printed male connector compared to the dimensions that are written or provided in typical specifications.

Turning now to the figures in which like numerals represent like elements throughout the several views, exemplary embodiments, aspects and features of the present invention are described. For convenience, only some elements of the same group may be labeled with numerals. The purpose of the drawings is to describe exemplary embodiments of the present invention and not for production or limitation. Therefore, dimensions of components and features shown in the figures are chosen for convenience and clarity of presentation and are not necessarily shown to scale.

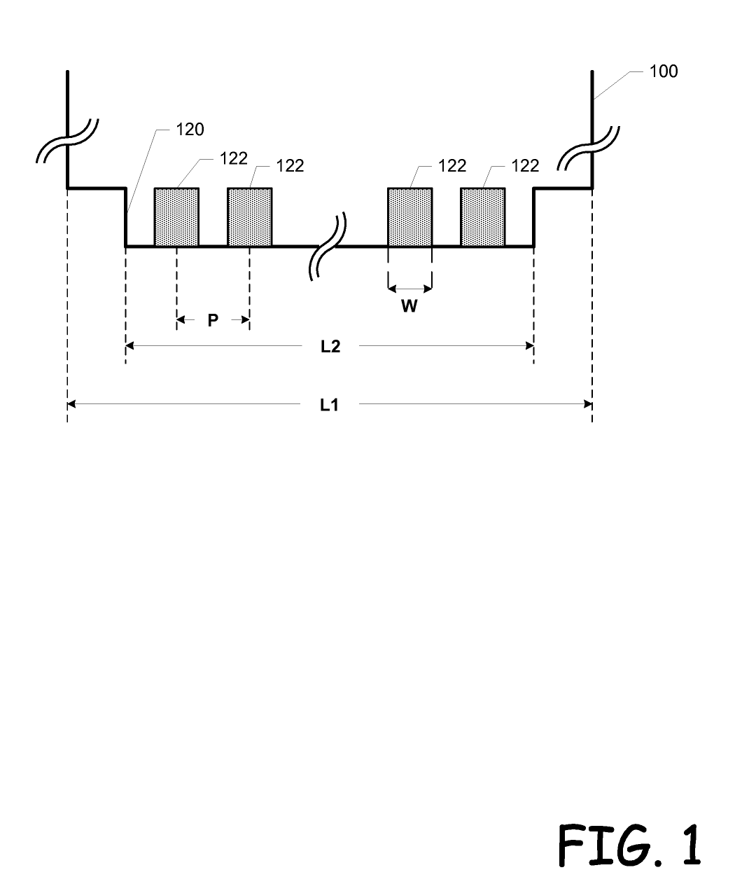

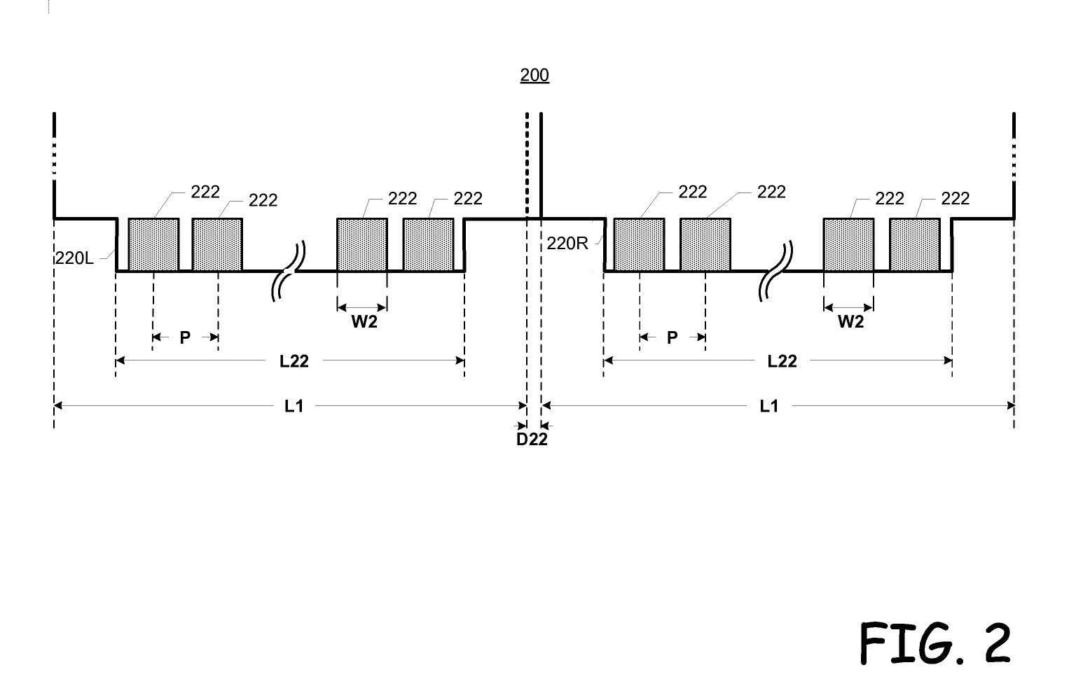

FIG. 2 is a schematic diagram a double size child card 200 having two card-edge interfaces (male connectors) 220L and 220R. The schematic shows relevant features of an edge of a PCB that has two card-edge interfaces (male connectors), each one having a set of golden fingers, wherein the two sets were designed according to an exemplary embodiment of the present invention. More specifically, each one of the male connectors has a set of golden fingers 222, wherein the two card-edge interfaces 220L and 220R matches an exemplary embodiment of the present invention. The total width of the double size child card 200 is two times L1 plus D22. Where L1 is the width of a single child card 100 (FIG. 1) and D22 is additional width that is required to comply with the requirement of the motherboard. A reliable electrical connection between the double sized child module and the motherboard can be achieved when the width L22 of each one of the card interface (male connectors) 220L and 220R is slightly reduced compare to the width L2 of the single child card interface (male connector) 120 (FIG. 1). In addition the width ‘W2’ of each golden finger 222 is slightly increased compare to width ‘W’ of each golden finger 122 (FIG. 1). The pitch ‘P’ remains without changes.

For example, when the double sized child card 200 is designed to replace a double module PCB according to the AMC.0 Specification, then the total width of the child card 200 (two times L1 plus D22) is 148.5+0.1 mm; L22 can be set to 64.95 mm±0.1, slightly smaller than the requirement of the specification (65+0.1 mm); ‘W2’ can be set to 0.52 mm±0.02, slightly bigger than the requirement of the specification (0.48+0.02 mm). The pitch ‘P’ is the same as defined by the specification (0.75 mm). The AMC.0 Specification R1.0 ECR-002 D0.8 dated Apr. 28, 06 is used as an exemplary specification of an interface between a child card and a motherboard. The present invention is not limited to this specification, although aspects of such specification may be included in novel embodiments of the present invention.

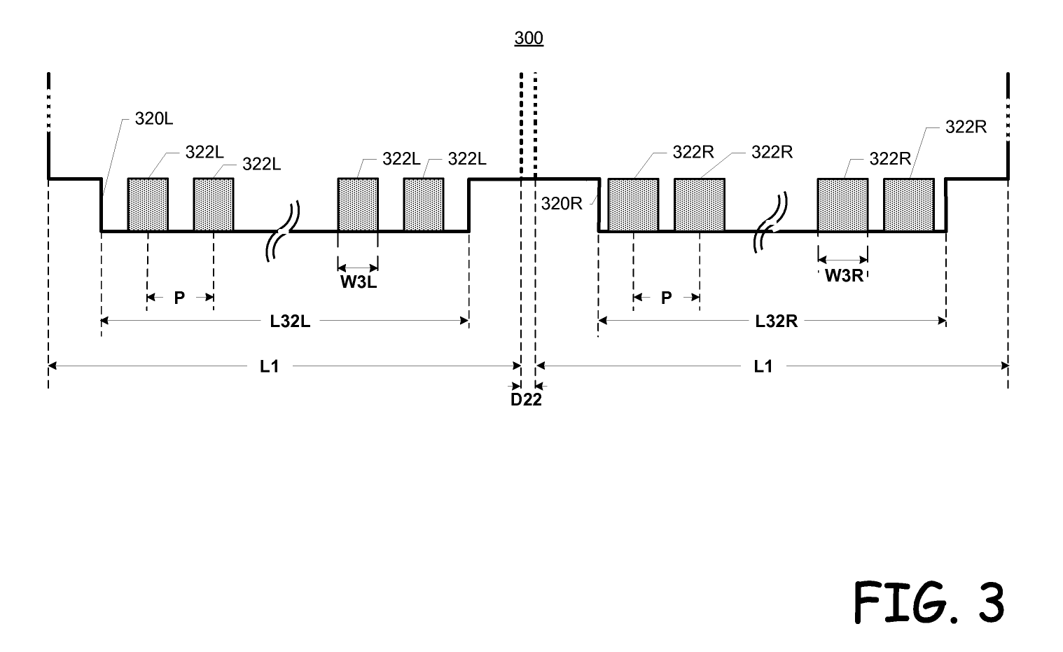

FIG. 3 is a schematic diagram of a double sized child card 300 having two card-edge interfaces (male connectors) 320L and 320R. The schematic shows relevant features of an edge of a PCB having two card-edge interfaces (male connectors). More specifically, the left card-edge interface (male connector) 320L has a set of golden fingers 322L. The right card-edge interface (male connector) 320R has a set of golden fingers 322R. The two card-edge interfaces 320L and 320R matches another exemplary embodiment of the present invention.

The total width of the double sized child card 300 is two times L1 plus D22, where L1 is the width of a single child card 100 (FIG. 1) and D22 is additional width that is required to match the requirement of the motherboard. Advantageously, a reliable electrical connection between the double sized child module 300 and the motherboard can be achieved when the width L32L of the left PCB card interface (male connectors) 320L and the width of the left golden fingers ‘W3L’ have the same values as similar elements in the single child card interface (male connector) 120 (FIG. 1). L32L has the same value of ‘L2’ and ‘W3L’ has the same value as ‘W’. In addition, the right PCB card interface (male connectors) 320R is slightly modified compared to a PCB card interface (male connectors) 120 of a single module (FIG. 1). The width L32R of the PCB card interface (male connectors 320R is slightly reduced compare to the width L2 of the single child card interface (male connector) 120 (FIG. 1). In addition the width ‘W3R’ of each golden finger 322R is slightly increased compared to width ‘W’ of each golden finger 122 (FIG. 1).

It should be appreciated that although the various embodiments of the present invention presented herein have only shown single-sided male connectors, that the present invention can also be employed when the printed card-edge male connector is double-sided having gold fingers on both sides of the PCB.

In the description and claims of the present disclosure, “comprise,” “include,” “have,” and conjugates thereof are used to indicate that the object or objects of the verb are not necessarily a complete listing of members, components, elements, or parts of the subject or subjects of the verb.

It will be appreciated that the above described apparatus and methods may be varied in many ways, including, changing the order of steps, and the exact implementation used. The described embodiments include different features, not all of which are required in all embodiments of the present disclosure. Moreover, some embodiments of the present disclosure use only some of the features or possible combinations of the features. Different combinations of features noted in the described embodiments will occur to a person skilled in the art. Furthermore, some embodiments of the present disclosure can be implemented by combination of features and elements that have been described in association to different exemplary embodiments along the discloser. The scope of the invention is limited only by the following claims.

What is claimed is:

1. A method for improving the ability of attaining reliable electronic connections between a motherboard, having two female edge connectors, and a child card having two card-edge interfaces including printed male connectors, wherein each one of the printed male connectors has a plurality of golden fingers and the AMC.0 specification defines particular parameters for single male connectors interfacing to the female edge connectors, the method comprising the steps of:
modifying, at least one parameter of at least one out of the two card-edge interfaces, compared to the defined similar parameters of a single card-edge interface (male connector).

2. The method of claim 1, wherein the step of modifying at least one parameter further comprises the step of modifying the width of the at least one out of the two card-edge interfaces.

3. The method of claim 1, wherein the step of modifying at least one parameter further comprises the step of modifying the width of each one of the plurality of golden fingers of the at least one out of the two card-edge interfaces.

4. The method of claim 1, wherein the step of modifying at lease one parameter further comprising the steps of:
a. reducing the width of the at least one out of the two card-edge interfaces compared to the defined width of the single card-edge interface; and
b. increasing the width of each one of the plurality of golden fingers of the at least one out of the two card-edge interfaces compare to the defined width of each one of the plurality of the golden fingers of the single card-edge interface.

5. A child card to be connected to female connectors on a motherboard, the child card comprising:
at least two card-edge interfaces in the form of printed male connectors, each one of the printed male connectors having a plurality of printed conductive fingers;
wherein at least one out of the two card-edge interfaces is slightly different from a specification for interfacing a similar single card-edge interface printed male connector to a similar female connector.

6. The child card of claim 5, wherein the width of the at least one out of the two card-edge interfaces is slightly different from the width of the similar single card-edge interface printed male connector.

7. The child card of claim 5, wherein the width of each one of the plurality of the conductive fingers of the at least one out of the two card-edge interfaces is slightly different from the width of each one of the plurality of conductive fingers of the similar single card-edge interface printed male connector.

8. The child card of claim 5, wherein the width of each one of the plurality of the conductive fingers of the at least one out of the two card-edge interfaces is slightly wider than the width of each one of the plurality of conductive fingers of the similar single card-edge interface printed male connector and the width of the at least one out of the two card-edge interfaces is slightly smaller than the width of the similar single card-edge interface printed male connector.

9. The child card of claim 5, wherein the single card-edge interface complies with the AMC.0 Specification.

10. The child card of claim 9, wherein the child card is a mezzanine card and the motherboard is a carrier card.

11. The child card of claim 10, wherein the child card can be inserted into a double bay on the carrier card.

12. A printed circuit board having at least two printed male connector card-edge interfaces, the printed circuit board being designed for mounting to another structure through a plurality of female receptacles that correspond to each printed male connector card-edge interface, the printed circuit board comprising:
a first printed mail connector card-edge interface having a width LL and a plurality of conductive fingers with each conductive finger having a width of WL;
a second printed mail connector card-edge interface having a width of LR and a plurality of conductive fingers with each conductive finger having a width of WR; and
wherein a specification for the female receptacles defines acceptable parameters for a male connector as including a width of LS and a conductive finger width of WS and at least one of the values of LL, LR, WL and WR vary from the values of LS and WS.

13. The printed circuit board of claim 12, wherein LL=LS, WL=WS and at least one of the values of LR and WR do not respectfully equal LS and WS.

14. The printed circuit board of claim 12, wherein LL=LS, WL=WS, LR does not equal LS and WR does not equal WS.

15. The printed circuit board of claim 12, wherein LR does not equal LS and WR does not equal WS.

16. The printed circuit board of claim 12, wherein LR is less than LS.

17. The printed circuit board of claim 12, wherein WR is greater than WS.

18. The printed circuit board of claim 12, wherein LL and LR are less than LS and WL and WR are greater than WS.

19. The printed circuit board of claim 12, wherein LL and LR are less than LS.

20. The printed circuit board of claim 12, wherein WL and WR are greater than WS.

21. The printed circuit board of claim 12, wherein the values of LS and WS comply with the AMC.0 Specification.

22. The printed circuit board of claim 12, wherein the printed circuit board is a mezzanine card and the another structure is a carrier card.

23. The printed circuit board of claim 22, wherein the printed circuit board can be inserted into a double bay on the carrier card.
